(19) United States
(12) Patent Application Publication
(10) Pub. No.: US 2023/0264749 A1
(43) Pub. Date: Aug. 24, 2023

(54) VEHICULAR INTERIOR COMPONENT

(71) Applicant: TOYOTA BOSHOKU KABUSHIKI KAISHA, Aichi-ken (JP)

(72) Inventors: Tsutomu TAKAGI, Gifu-ken (JP); Yosuke TAGAMI, Gifu-ken (JP)

(73) Assignee: TOYOTA BOSHOKU KABUSHIKI KAISHA, Aichi-ken (JP)

(21) Appl. No.: 18/090,857

(22) Filed: Dec. 29, 2022

(30) Foreign Application Priority Data
Feb. 24, 2022 (JP) 2022-026399

(51) Int. Cl. B62D 25/06; B60R 13/02; B32B 3/30; B32B 5/18; B32B 5/02; B32B 27/06; B32B 27/12; B32B 27/36; B32B 27/34; B32B 27/32; B32B 27/08

(52) U.S. Cl. CPC B62D 25/06; B60R 13/0212; B32B 3/30; B32B 5/18; B32B 5/022; B32B 27/065; B32B 27/12; B32B 27/36; B32B 27/34; B32B 27/32; B32B 27/08; G02B 5/0808

(57) ABSTRACT

A vehicular interior component to be mounted on a body panel includes a core layer having a vehicular exterior side surface and a cover layer covering the vehicular exterior side surface of the core layer and having a cover layer vehicular exterior surface. The cover layer includes a first section and a second section. The first section has a first vehicular exterior side surface that is flat and is a portion of the cover layer vehicular exterior surface and the second section has a second vehicular exterior side surface that is an uneven surface and is another portion of the cover layer vehicular exterior side surface. The second section includes projection portions that are to be contacted with the body panel or a vehicular component.

### CROSS REFERENCE TO RELATED APPLICATION

This application claims priority from Japanese Patent Application No. 2022-26399 filed on Feb. 24, 2022. The entire contents of the priority application are incorporated herein by reference.

### TECHNICAL FIELD

The technology described herein relates to a vehicular component.

### BACKGROUND

A vehicular interior component (an automobile interior component) that is mounted on a roof panel of an automobile body with a mounting member has been known. Such a vehicular interior component includes a base member and an infrared reflective layer and the vehicular interior component is mounted on the roof panel such that the infrared reflective layer is opposite the roof panel. With such a configuration, even if sun light hits the roof panel from the above, heat from the sun light is blocked by the infrared reflective layer.

However, in such a configuration, when the automobile is moving and vibration is caused, rubbing of the vehicular interior component with the automobile body or other vehicular components may be caused and this may cause noise. Particularly in a configuration that a cover layer such as the infrared reflective layer is disposed on a rear side surface (that is opposite the roof panel) of the base member, the rear side surface of the base member is flat with the cover layer. This increases friction between the cover layer and the automobile body or other vehicular components and noise is likely to be caused. To suppress such noise, a buffer member may be disposed on a rear side surface of the portions of the vehicular interior component where the noise is likely to be caused. However, this increases works and a cost. Furthermore, with the buffer member being disposed between the automobile body and the infrared reflective layer, heat reflected by the infrared reflective layer is blocked by the buffer member and the infrared reflective layer may not exert its function effectively.

### SUMMARY

The technology described herein was made in view of the foregoing circumstances. An object is to provide a vehicular interior component that suppress noise. Another object is to provide a vehicular interior component that can reduce a cost with a simple configuration. Further another object is to provide a vehicular interior component that can exert a function of heat reflection.

The present disclosure is related to a vehicular interior component to be mounted on a body panel. The vehicular interior component includes a core layer having a vehicular exterior side surface and a cover layer that covers the vehicular exterior side surface of the core layer and has a cover layer vehicular exterior surface. The cover layer includes a first section and a second section. The first section has a first vehicular exterior side surface that is flat and is a portion of the cover layer vehicular exterior surface. The second section has a second vehicular exterior side surface that is an uneven surface and is another portion of the cover layer vehicular exterior side surface. The second section includes projection portions that are to be contacted with the body panel or a vehicular component.

### BRIEF DESCRIPTION OF THE DRAWINGS

FIG. 1 is a side view of an automobile according to one embodiment.

FIG. 2 is a cross-sectional view of a roof panel, a curtain airbag, and a ceiling member.

FIG. 3 is an upper view of the ceiling member.

FIG. 4 is a cross-sectional view illustrating a cross-sectional configuration of the ceiling member including a first section.

FIG. 5 is a cross-sectional view illustrating a cross-sectional configuration of the ceiling member including a second section.

FIG. 6 is a cross-sectional view illustrating a cross-sectional configuration of a ceiling member according to another embodiment.

### DETAILED DESCRIPTION

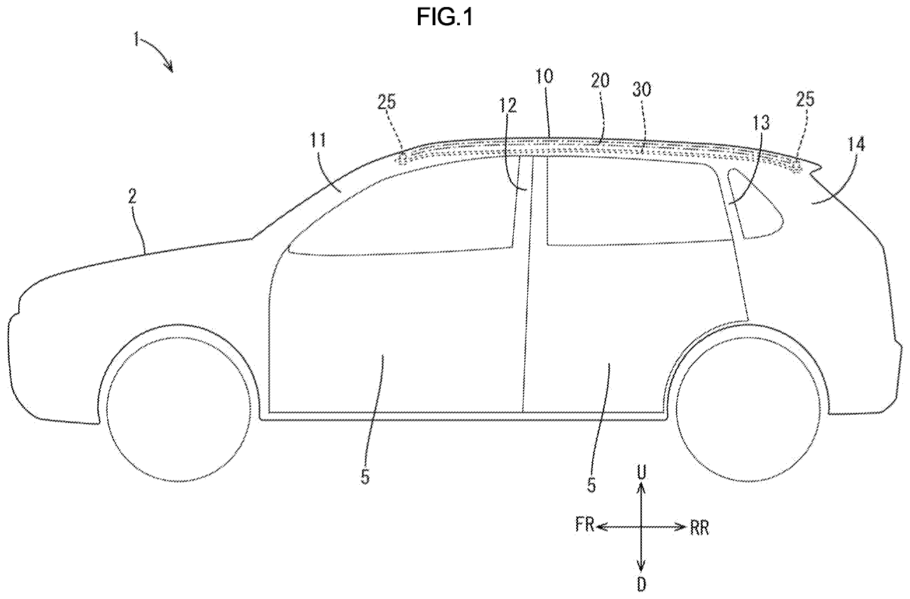

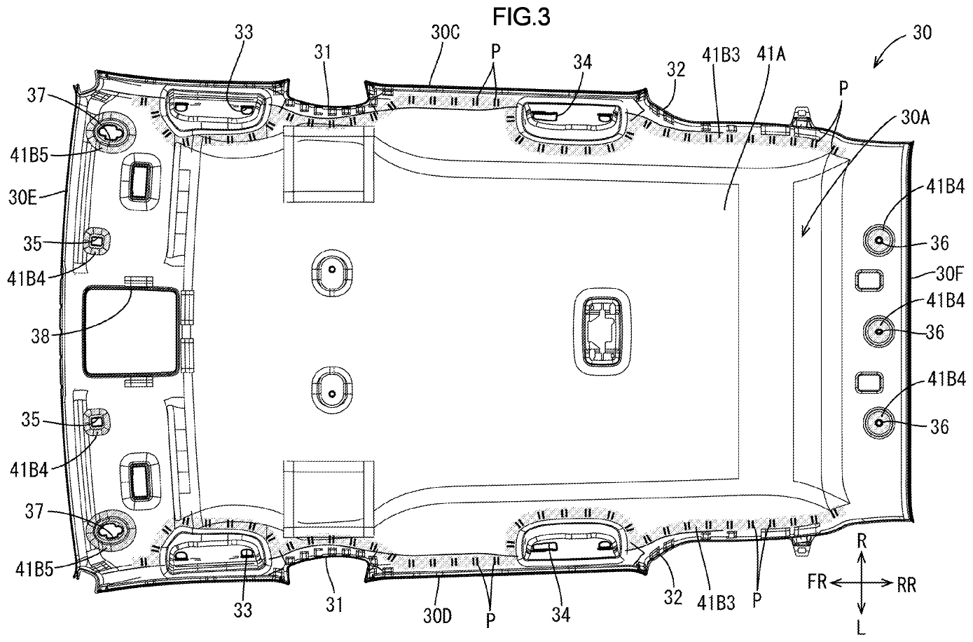

One embodiment of the present disclosure will be described in detail with reference to FIGS. 1 to 5. In this section, a ceiling member 30 (a vehicular interior component) that is installed in an automobile 1 (a vehicle) will be described. Arrow directions FR, RR, U, D, L, R represent a front direction, a rear direction, an upper direction, a lower direction, a left direction, and a right direction, respectively. FIG. 3 illustrates the ceiling member 30 seen from the above (a vehicular exterior side).

As illustrated in FIG. 1, the automobile 1 includes a body panel 2 made of a metal plate. The body panel 2 forms an outline of the automobile 1. The body panel 2 includes door panels 5, a roof panel 10, and pillar panels. The door panels 5 are configured as right doors and left doors of the automobile 1. The roof panel 10 is configured as an upper wall of the automobile 1. The pillar panels have an elongated shape extending in an upper-bottom direction and support the roof panel 10 from below. The pillar panels include A-pillar panels 11, B-pillar panels 12, C-pillar panels 13, and a D-pillar panel 14 from the front side of the automobile 1. The D-pillar panel 14 is disposed in a rear section of the automobile 1.

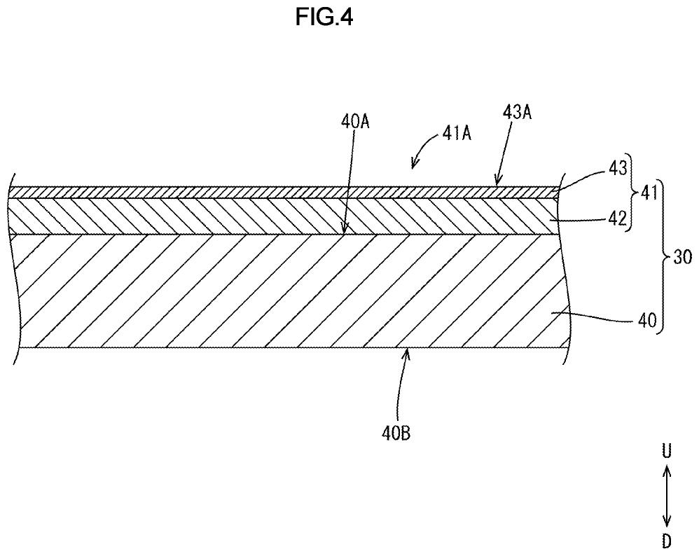

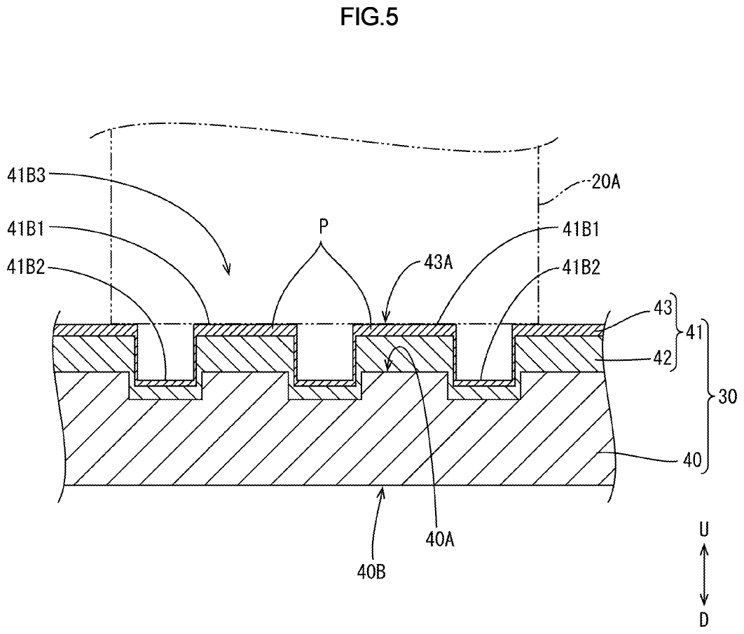

The automobile 1 includes the ceiling member 30 and curtain airbags 20 (a vehicular component). The ceiling member 30 is mounted on the roof panel 10 from the vehicular interior side (from below) and configured as a ceiling of a vehicular compartment of the automobile 1. The curtain airbags 20 are disposed between the roof panel 10 and the ceiling member 30. As illustrated in FIG. 3, the ceiling member 30 is a plate member having a rectangular shape elongated in a vehicular front-rear direction. A plate surface of the ceiling member 30 extends in the vehicular front-rear direction and a right-left direction (a vehicular width direction). In FIGS. 4 and 5, a vertical direction corresponds to a thickness direction of the ceiling member 30. A vehicular exterior side surface 30A of the ceiling member 30 is opposite the roof panel 10 and the curtain airbags 20.

As illustrated in FIG. 3, the ceiling member 30 includes recessed portions 31, 32 and assist grip holes 33, 34 on a right side edge portion 30C and a left side edge portion 30D. The recessed portions 31, 32 are recessed inwardly (toward a middle section) from right and left side edges of the ceiling member 30. The assist grip holes 33, 34 are through the ceiling member 30 in the thickness direction. Assist grips that are to be held by passengers onboard the automobile 1 are to be mounted in the assist grip holes 33, 34. The recessed portions 31 are recessed such that peripheral edges of the recessed portions 31 extend along an outline of the B-pillar panel 12 and the recessed portions 31 receive the B-pillar panels therein. The recessed portions 32 are recessed such that peripheral edges of the recessed portions 32 extend along an outline of the C-pillar panel 13 and the recessed portions 32 receive the C-pillar panels therein.

As illustrated in FIG. 3, the ceiling member 30 includes holes in a front end portion 30E. The holes are through the ceiling member 30 in the thickness direction. The holes include clip holes 35, sun visor holes 37, and a lighting device hole 38. Clips 25 (refer to FIG. 1) are inserted through the clip holes 35, respectively, to fix the front end portion 30E of the ceiling member 30 to the roof panel 10. Sun visors are fixed to the ceiling member 30 via the sun visor holes 37, respectively. A lighting device for lighting the vehicular compartment is mounted in the ceiling member 30 via the lighting device hole 38. The ceiling member 30 includes clip holes 36 in a rear end portion 30F. The clips 25 (refer to FIG. 1) are inserted through the clip holes 36, respectively, to fix the rear end portion 30F to the roof panel 10. The clip holes 36 are through the ceiling member 30 in the thickness direction. Hole edge portions of the clip holes 35, 36 and hole edge portions of the sun visor holes 37 are contacted with the vehicular interior side surface of the roof panel 10 when the ceiling member 30 is fixed to the roof panel 10. The hole edge portions of the clip holes 35, 36 and the sun visor holes 37 correspond to panel-side contact portions (second sections 41B4, 41B5).

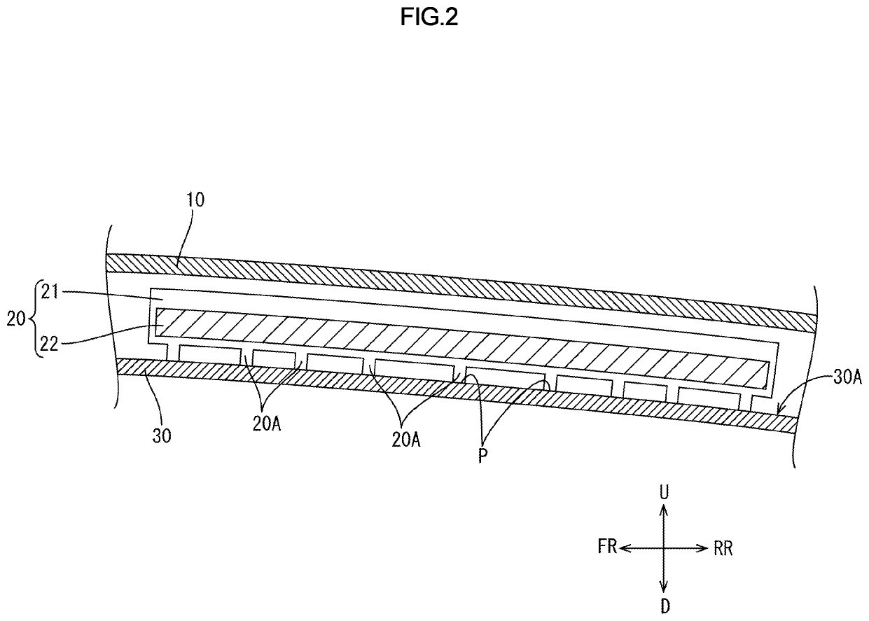

As illustrated in FIGS. 1 and 2, the curtain airbags 20 extend in the vehicular front-rear direction. Two curtain airbags 20 are disposed on a right side portion and a left side portion of the ceiling member 30, respectively, and between the roof panel 10 and the ceiling member 30. The curtain airbag 20 includes a resin case 21 that has a box shape extending in the vehicular front-rear direction and a bag 22 stored in the resin case 21. The bag 22 that can be inflated is wound up and stored in the resin case 21 (a normal state). With the bag 22 being stored in the resin case 21, the curtain airbag 20 is fixed to the roof panel 10 or the ceiling member 30. When the curtain airbag 20 deploys, gas flows from an inflator into the bag 22 and the bag 22 is inflated and comes out of the resin case 21. Then, the bag 22 pushes down the right side edge portion 30C and the left side edge portion 30D (refer to FIG. 3) of the ceiling member 30 and deploys in the vehicular interior room below the right side edge portion 30C and left side edge portion 30D. As illustrated in FIGS. 2 and 5, the curtain airbag 20 includes support portions 20A (ribs) that are to be contacted with portions of the right side edge portion 30C and left side edge portion 30D of the ceiling member 30. In FIG. 3, the portions of the right side edge portion 30C and the left side edge portion 30D that are to be contacted with the support portions 20A are illustrated with pairs of short solid lines and defined as curtain airbag contact portions P. The curtain airbag contact portions P include contact portions 41B1 (projection portions), which will be described later. The curtain airbag contact portions P are included in a second section 41B3, which will be described later. The curtain airbag contact portions P are arranged in the vehicular front-rear direction along the edges of the right side edge portions 30C and the left side edge portion 30D of the ceiling member 30. Some of the curtain airbag contact portions P are arranged in an inwardly curved form around the assist grip holes 33, 34.

As illustrated in FIGS. 4 and 5, the ceiling member 30 includes a core layer 40 and a cover layer 41 that covers a vehicular exterior side surface 40A of the core layer 40. The cover layer 41 includes a reflective layer 43 and an air blocking layer 42. The reflective layer 43 reflects at least infrared light. The air blocking layer 42 is disposed between the reflective layer 43 and the core layer 40 and prevents air from moving at least in the thickness direction of the cover layer 41 (the upper-bottom direction). A vehicular interior side surface 40B of the core layer 40 may be exposed to the vehicular compartment or may be covered with a skin that provides a certain design.

The core layer 40 is a base member that is a plate member extending in the vehicular front-rear direction and the right-left direction. Materials of the core layer 40 may include one, two or more of porous fiber material, hard foamed material, and composite material of hard foamed material and non-woven cloth. An example of the porous fiber material may be hard fiber such as glass fiber, PET fiber, and plant fiber including thermoplastic resin as binder resin. An example of the hard foamed material may be polyurethane (including hard polyurethane and semi-hard polyurethane), polyolefin, and other foamed resin. Among the above materials, foamed material of polyurethane is preferable and foamed material of semi-hard polyurethane is more preferable. An example of the composite material of hard foamed material and non-woven cloth may be composite material obtained by joining non-woven cloth made of hard fiber such as glass fiber onto at least one surface of front and rear surfaces of the hard foamed material.

The air blocking layer 42 is configured to prevent air from moving at least in the thickness direction of the cover layer 41 and also configured as a base film for holding the reflective layer 43 on the core layer 40. A thickness of the air blocking layer 42 is smaller than a thickness of the core layer 40 and greater than a thickness of the reflective layer 43. Specifically, the thickness of the air blocking layer 42 may be in the range from any of 5 μm or greater, 10 μm or greater, and 15 μm or greater to any of 60 μm or less, 40 μm or less, 25 μm or less. The thickness of the air blocking layer 42 is preferably 20 μm. An example of material for the air blocking layer 42 may be thermoplastic resin. Specifically, one, two or more of thermoplastic resins including polyester resin, polyamide resin, polyolefin resin, cyclic polyolefin resin, polyvinyl alcohol resin, and ethylene-vinyl alcohol copolymer may be used for the air blocking layer 42. With respect to forming, polyester resin and polyamide resin are preferable and polyamide resin is more preferable. An example of such polyamide resin is an unstretched nylon film. In a configuration using thermoplastic resin such as polypropylene as the material of the core layer 40, resin having a melting point of 200° or higher is preferably used as the material of the air blocking layer 42. In a configuration using thermosetting resin such as polyurethane as the material of the core layer 40, polypropylene resin having a melting point of 160° may be used as the material of the air blocking layer 42.

The air blocking layer 42 is bonded to the core layer 40 with adhesive. The adhesive may be immersed into the core layer 40 or a small amount of cured adhesive may remain between the air blocking layer 42 and the core layer 40 as an adhesive layer. In the configuration using thermoplastic resin as the material of the core layer 40, thermoplastic resin having a melting point that is lower than that of the core layer 40 may be used as the adhesive (the adhesive layer). For example, polypropylene resin, acid modified polypropylene resin, or ethylene resin such as polyethylene and copolymer of polyethylene may be used as the adhesive. In the configuration using thermosetting resin as the material of the core layer 40, diphenylmethanediisocyanate (MDI) may be used as the adhesive.

The reflective layer 43 is configured to reflect light (infrared light) having the wavelength range from 0.7 μm to 1000 μm, inclusive. The wavelength range of light may be in the range from any of 2 μm or higher and 4 μm or higher to 20 μm or lower. The reflective layer 43 may be configured to reflect light (infrared light) having the wavelength range from 4 μm to 1000 μm, inclusive. The reflective layer 43 may reflect light having the wavelength range from 4 μm to 1000 μm, inclusive, and light having the wavelength range outside the above wavelength range. Regarding reflectance of the light, infrared reflectance of the light having the wavelength range from 2 μm to 20 μm, inclusive, may be 55% or higher and may be 60% or higher. With respect to improving the reflection function of infrared light and the cost reduction, the thickness of the reflective layer 43 may be in the range from any of 0.1 μm or greater, 0.5 μm or greater, and 1 μm or greater to any of 10 μm or smaller, 5 μm or smaller, 2 μm or smaller, and 1.5 μm or smaller.

The reflective layer 43 is produced by disposing scaly metal flake containing coating material on the air blocking layer 42 (gravure printing). The scaly metal flake containing coating material includes resin and scaly metal flake pigments made of metal such as aluminum, gold, indium, and copper. A preferable example of the scaly metal flake pigments is leafing aluminum flake pigments. The leafing aluminum flake pigments are obtained by coating surfaces of the scaly aluminum powders having a long diameter of 1 μm to 150 μm with treatment agent such as stearic acid. With the rear surface of the air blocking layer 42 (a thermoplastic resin film such as an unstretched nylon film) being coated with the coating material containing such pigments, the scaly aluminum powders move to the surface of the coating layer and are arranged parallel to each other. Thus, the reflective layer 43 including the scaly metal flakes that are arranged at intervals and the resin for preventing contact between the scaly metal flakes is formed.

Examples of the resin included in the scaly metal flake containing coating material (the resin that prevents contact between the scaly metal flakes in the coating layer) include alkyd resin, acrylic resin, epoxy resin, olefin resin, polyamide resin, polyurethane resin, polyester resin, polybutadiene resin, and modified resin thereof. Among the examples of the resin, polyurethane resin is preferable. With such a reflective layer 43, surface resistivity of the reflective layer 43 can be increased. For example, even if a metal wire that is inside electric wiring disposed between the roof panel 10 and the ceiling member 30 is uncovered due to some reason, a short circuit is less likely to be caused between the uncovered metal wire and the reflective layer 43.

As illustrated in FIGS. 3 to 5, the cover layer 41 includes a first section 41A, which corresponds to a most portion of the ceiling member 30, and second sections 41B3, 41B4, 41B5. The first section 41A corresponds to a middle section of the ceiling member 30 and the second sections 41B3 are included in the right side edge portion 30C and the left side edge portion 30D, and the second sections 41B4, 41B5 are included in the front end portion 30E and the rear end portion 30F. The cover layer 41 has a vehicular exterior side surface 43A (a cover layer vehicular exterior side surface), which corresponds to the vehicular exterior side surface 30A of the ceiling member 30. The vehicular exterior side surface 43A (a first vehicular exterior side surface) of the first section 41A is flat. The vehicular exterior side surfaces 43A (second vehicular exterior side surface) of the second sections 41B3, 41B4, 41B are uneven and include contact portions 41B1 (projection portions) and recessed portions 41B2 (recesses).

FIG. 4 illustrates a cross-sectional configuration of the ceiling member 30 including the first section 41A of the cover layer 41. The first section 41A corresponds to a portion of the ceiling member 30 other than the portions thereof adjacent to the contact portions 41B1 that are contacted with the roof panel 10 or the curtain airbag 20. As illustrated in FIG. 4, the vehicular exterior side surface 40A of the core layer 40 corresponding to the first section 41A is a flat surface. The vehicular exterior side surface (a first vehicular exterior side surface) of the first section 41A of the cover layer 41 is a flat surface. Namely, the vehicular exterior side surface 30A of the ceiling member 30 including the first section 41A is a flat surface. FIG. 5 illustrates a cross-sectional configuration of the ceiling member 30 including the second section 41B3 of the cover layer 41. The second sections 41B3, 41B4, 41B5 have a same configuration and the second section 41B3 will be described with reference to FIG. 5. As illustrated in FIG. 5, the second section 41B3 includes the contact portions 41B1 and the recessed portions 41B2. The contact portions 41B1 are to be contacted with the roof panel 10 or the support portions 20A of the curtain airbag 20. In FIG. 3, the second sections 41B3, 41B4, 41B5 of the ceiling member 30 are illustrated with small dots and the first section 41A corresponds to a portion of the ceiling member 30 other than the second sections 41B3, 41B4, 41B5.

The second sections 41B3 are included in the right side edge portion 30C and the left side edge portion 30D and opposite the curtain airbags 20. The second sections 41B3 are on the vehicular exterior side of the first section 41A with respect to the vehicular width direction and have a belt shape extending in the vehicular front-rear direction. The second sections 41B4, 41B5 are at and around the hole edges (panel-side contact portions) of the clip holes 35, 36 and the sun visor holes 37 and have a ring shape (a circular shape). The belt-shaped second section 41B3 is partially curved along the assist grip holes 33, 34 so as to protrude inward (toward a middle section of the ceiling member 30). The belt-shaped second section 41B3 includes the curtain airbag contact portions P. As illustrated in FIG. 5, the contact portions 41B1 of the belt-shaped second section 41B3 are contacted with the support portions 20A of the curtain airbag 20 at the curtain airbag contact portions P. As illustrated in FIG. 1, with the ceiling member 30 being mounted on the roof panel 10 with the clips 25, the contact portions 41B1 of the ring-shaped second sections 41B4, 41B5 are contacted with portions of the roof panel 10 adjacent to the clip holes 35, 36 and the sun visor holes 37. The belt-shaped second sections 41B3 and the ring-shaped second sections 41B4, 41B5 have a same configuration including the contact portions 41B1 and the recessed portions 41B2.

FIG. 5 illustrates a cross-sectional configuration of the ceiling member 30 including the belt-shaped second section 41B3. The second section 41B3 is included on the vehicular exterior side surface 30A of the ceiling member 30. The second section 41B3 is included in the reflective layer 43. The second section 41B3 includes the contact portions 41B1 and the recessed portions 41B2. The contact portions 41B1 are projection portions between the recessed portions 41B2. The contact portions 41B1 are to be contacted with the roof panel 10 or the support portions 20A of the curtain airbag 20. The vehicular exterior side surfaces 43A of the contact portions 41B1 are portions of the vehicular exterior side surface 30A of the ceiling member 30. That is, the upper surfaces of the contact portions 41B1 are contact surfaces and are portions of the vehicular exterior side surface 43A (a cover layer vehicular exterior side surface) of the cover layer 41. The recessed portions 41B2 are recessed toward the vehicular interior side than the contact portions 41B1. The recessed portions 41B2 are recessed from the vehicular exterior side surface 30A of the ceiling member 30. Namely, the recessed portions 41B2 are recessed from the vehicular exterior side surface 43A of the cover layer 41. With the curtain airbag 20 being mounted on the ceiling member 30, the contact portions 41B1 are contacted with the curtain airbag 20 but the recessed portions 41B2 are not contacted with the curtain airbag 20. With the curtain airbag 20 being mounted on the ceiling member 30, a space is between a bottom surface of the recessed portion 41B2 and the support portion 20A. Namely, the bottom surface of the recessed portion 41B2 is away from the support portion 20A. Directly below the recessed portions 41B2, portions of the air blocking layer 42 and the core layer 40 that are included in lower layers than the reflective layer 43 are recessed toward the vehicular interior side. The bottom surfaces (vehicular interior side surfaces of the recessed portions 41B2) of the recessed portions 41B2 are lower (on the vehicular interior side) than portions of the vehicular exterior side surface 40A of the core layer 40 that are directly below the contact portions 41B1.

The depth (a distance between the vehicular exterior side surface 43A of the contact portion 41B1 and the bottom surface of the recessed portion 41B2) of the recessed portion 41B2 may be in the range from any of 0.005 mm or greater, 0.01 mm or greater, and 0.02 mm or greater to any of 2 mm or smaller, 1 mm or smaller, and 0.1 mm or smaller. The depth of the recessed portion 41B2 may be preferably between 0.02 mm and 1 mm, inclusive. The depth of the recessed portion 41B2 may be greater than a total of the thickness of the air blocking layer 42 and the reflective layer 43. With the depth of the recessed portion 41B2 being within such a range, recesses (first recesses) are formed in the vehicular exterior side surface 40A of the core layer 40. This improves durability of the uneven shape of the vehicular exterior side surface 30A of the ceiling member 30. Furthermore, deterioration in design of the vehicular interior side surface 40B of the core layer 40 is suppressed.

The distance between the contact portions 41B1 that are adjacent to each other (a dimension of the recessed portion 41B2) may be in the range from any of 0.05 mm or greater and 0.1 mm or greater to any of 10 mm or smaller and 5 mm or smaller. The distance between the adjacent contact portions 41B1 is preferably between 0.1 mm and 5 mm, inclusive. A ratio of the area of the contact portions 41B1 that are contacted with the support portions 20A to the area of the second section 41B3 is preferably between 30% and 70%, inclusive. Similarly, a ratio of the area of the contact portions 41B1 that are contacted with the roof panel 10 to the area of the second section 41B4, 41B5 is preferably between 30% and 70%, inclusive. With the ratio being within such a range, friction can be reduced effectively. This suppresses concentration of stress from the roof panel 10 or the support portions 20A on the reflective layer 43 and the reflective layer 43 and the air blocking layer 42 are less likely to be broken.

With using thermoplastic resin as the material of the core layer 40, a preboard is obtained by disposing the air blocking layer 42 and the reflective layer 43 on the core layer 40 and the preboard is exposed to hot air in a furnace and heated by a far-infrared heater. Then, cold pressing is performed for the heated preboard and the ceiling member 30 is obtained. With using thermosetting resin as the material of the core layer 40, a preboard is obtained by disposing the air blocking layer 42 and the reflective layer 43 on the core layer 40 and hot pressing is performed for the preboard at about 130°. Thus, the ceiling member 30 is obtained. In the process of pressing, the rear surface of the preboard is pressed with a molding die partially having embossing form and the rear surface of the ceiling member 30 is embossed to form the second sections 41B3, 41B4, 41B5. Such embossing form is provided on a nesting die that is removably attached to the molding die. The nesting die may be made of the material (metal) same as that of the molding die or may be made of resin (thermosetting resin such as epoxy resin and phenol resin) having good heat resistance and durability.

Next, effects of this embodiment will be described. The ceiling member 30 (the vehicular interior component) according to this embodiment is to be mounted on the roof panel 10 of the automobile 1 from the vehicular interior side and includes the core layer 40 and the cover layer 41 that covers the vehicular exterior side surface 40A of the core layer 40. The cover layer 41 includes the first section 41A and the second sections 41B3, 41B4, 41B5. The first section 41A has a flat vehicular exterior side surface. The second sections 41B3, 41B4, 41B5 have an uneven vehicular exterior side surface. The second sections 41B3, 41B4, 41B5 include the contact portions 41B1 on the vehicular exterior side surface 43A. The contact portions 41B1 are to be contacted with a vehicular component such as the curtain airbag 20, which is disposed between the roof panel 10 and the ceiling member 30, or the roof panel 10.

According to such a ceiling member 30 (the vehicular interior component), the second sections 41B3, 41B4, 41B5 of the cover layer 41, which covers the vehicular exterior side surface 40A of the core layer 40, include the contact portions 41B1 that are to be contacted with the curtain airbag 20 (the vehicular component) or the roof panel 10 (the body panel). Thus, the second sections 41B3, 41B4, 41B5 have an uneven vehicular exterior side surface. The second sections 41B3, 41B4, 41B5 include the recessed portions 41B2 between the adjacent contact portions 41B1. The recessed portions 41B2 are not contacted with the curtain airbag 20 or the roof panel 10. With the second sections 41B3, 41B4, 41B5 being provided, an area of the contact surface of the cover layer 41 that is contacted with the curtain airbag 20 or the roof panel 10 can be reduced. Namely, an area of the contact surface of the ceiling member 30 that is to be contacted with the curtain airbag 20 or the roof panel 10 can be reduced. Therefore, friction between the ceiling member 30 and the curtain airbag 20 or the roof panel 10 can be reduced and noise is less likely to be caused. A buffer member for suppressing such noise is not necessary to be disposed at the contact portions. Therefore, a cost can be reduced with a simple configuration.

The cover layer 41 includes the reflective layer 43 that reflects at least infrared light and includes the second sections 41B3, 41B4, 41B5 in the reflective layer 43. According to such a ceiling member 30 (vehicular interior component), infrared light (heat) can be reflected by the reflective layer 43 with suppressing noise. Accordingly, a comfortable vehicular interior space can be provided. A buffer member for suppressing noise is not necessary to be disposed. Therefore, the effects of the reflective layer 43 is not hindered by the buffer member.

The cover layer 41 includes the air blocking layer 42 between the reflective layer 43 and the core layer 40. The air blocking layer 42 is for preventing movement of air in the thickness direction. According to such a ceiling member 30 (vehicular interior component), air is less likely to move in the thickness direction and infrared light is reflected by the reflective layer 43 with suppressing noise. Accordingly, a comfortable vehicular interior space can be provided.

The recessed portions 41B2 of the second sections 41B3, 41B4, 41B5 are recessed further in the core layer 40. The vehicular exterior side surface 40A of portions of the core layer 40 that are directly below (on the vehicular interior side of) the recessed portions 41B2 has recessed portions. The uneven shape (projections and recesses) of the cover layer 41 is less likely to be lost due to aging change and durability of the uneven shape can be improved.

The curtain airbag 20 (vehicular component) extends in the vehicular front-rear direction. The second section 41B3 extends in the vehicular front-rear direction. The cover layer 41 includes the second sections 41B3 on outer sides with respect to the first section 41A in the vehicular width direction. The second sections 41B3 are opposite the curtain airbags 20, respectively.

With the curtain airbag 20 being mounted adjacent to the ceiling member 30 (vehicular interior component) that is elongated in the vehicular front-rear direction, an area of the surface of the ceiling member 30 (vehicular interior component) that is contacted with the elongated curtain airbag 20 is increased and noise may be likely to be caused. However, according to the ceiling member 30 of this embodiment, the area of the contact surface of the ceiling member 30 and the curtain airbag 20 can be reduced and noise is less likely to be caused.

The ceiling member 30 is configured as a ceiling of a vehicle. The ceiling member 30 is contacted with the roof panel 10 in a large area and with multiple contact portions. However, according to this embodiment, noise is less likely to be caused in the ceiling member 30 having the multiple contact portions.

### Second Embodiment

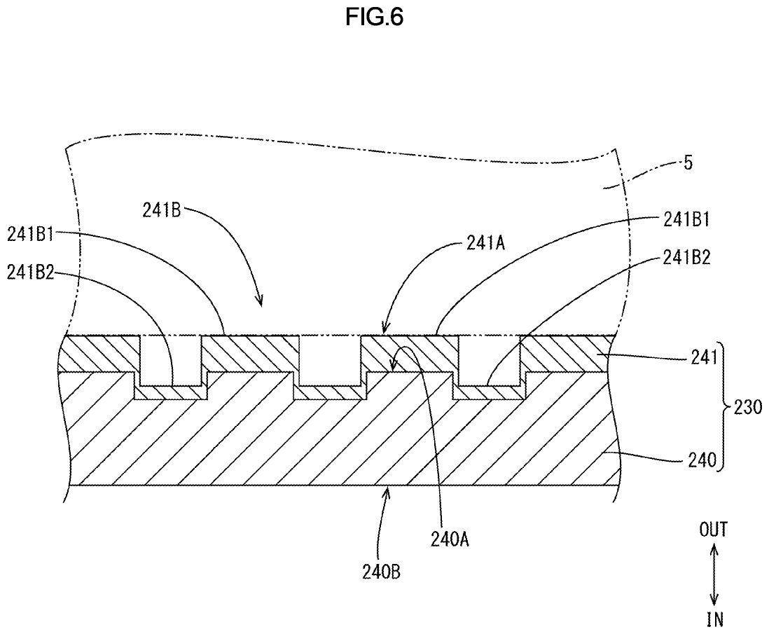

Next, a second embodiment will be described with reference to FIG. 6. As a vehicular interior component according to the second embodiment, a door trim 230 that is to be mounted on the door panel 5 (refer to FIG. 1) from the vehicular interior side will be described. The same symbols are used for the components of this embodiment that are same as those of the first embodiment and configurations, operations, and effects of the same components will not be described. Arrows IN and OUT point the vehicular interior side and the vehicular exterior side, respectively, in the drawings. With the door trim 230 being mounted on the left door panel 5 as illustrated in FIG. 1, the vehicular interior side and the vehicular exterior side correspond to the right side and the left side, respectively.

FIG. 6 illustrates a cross-sectional configuration of a portion of the door trim 230 that is contacted with the door panel 5 from the vehicular interior side. The door trim 230 includes a core layer 240 and an air blocking layer 241 that is configured as the cover layer and covers a vehicular exterior side surface 240A of the core layer 240. The air blocking layer 241 is for preventing movement of air in the thickness direction (a vehicular interior-exterior direction). In this embodiment, the door trim 230 does not include the reflective layer 43.

The door trim 230 has a plate shape. The air blocking layer 241 configured as the cover layer includes a first section that is on a middle section of the door trim 230 and a second section 241B that is on an outer edge portion of the door trim 230. The second section 241B includes contact portions 241B1 and recessed portions 241B2. The contact portions 241B1 are to be contacted with the door panel 5 when the door trim 230 is mounted on the door panel 5. The recessed portions 241B2 are disposed between the contact portions 241B1. The second section 241B has a vehicular exterior side surface 241A that is an uneven surface. The recessed portions 241B2 are recessed toward the vehicular interior side than the contact portions 241B1. The vehicular exterior side surface 241A of the second section 241B is a contact surface that is to be contacted with the door panel 5.

According to such a door trim 230, noise is less likely to be caused and air is less likely to move in the thickness direction with the air blocking layer 241. Accordingly, a comfortable vehicular interior space can be provided.

### OTHER EMBODIMENTS

The present disclosure is not limited to the embodiments described above and illustrated in the drawings. The following embodiments may be included in the technical scope of the technology described herein. The technology described herein may be modified within the technical scope.

(1) Vehicular interior components other than the ceiling member and the door trim may be used as a vehicular interior component. Vehicular interior component that is to be contacted with a vehicular component or a body panel may be a pillar garnish, an instrumental panel, and a scuff plate.

(2) The ceiling member may include a second section having an uneven surface adjacent to a hole edge of a clip hole in a middle section of the ceiling member or adjacent to a hole edge of a lighting device hole in a front middle section of the ceiling member.

(3) The curtain airbag may not include a resin case and the bag may be held by a band. In such a configuration, the band may be contacted with the contact portion of the second section having an uneven surface.

(4) The vehicular interior component may be used in vehicles on ground such as a train and an amusement vehicle, flying vehicles such as an airplane and a helicopter, and ocean vehicles such as a ship and underwater vehicles such as a submarine.

1. A vehicular interior component to be mounted on a body panel, the vehicular interior component comprising:
a core layer having a vehicular exterior side surface; and
a cover layer covering the vehicular exterior side surface of the core layer and having a cover layer vehicular exterior surface, the cover layer including
a first section having a first vehicular exterior side surface that is flat and is a portion of the cover layer vehicular exterior surface, and
a second section having a second vehicular exterior side surface that is an uneven surface and is another portion of the cover layer vehicular exterior side surface, the second section including projection portions that are to be contacted with the body panel or a vehicular component.

2. The vehicular interior component according to claim 1, wherein
the cover layer includes a reflective layer that reflects at least infrared light, and
the second section is included in the reflective layer.

3. The vehicular interior component according to claim 2, wherein the cover layer includes an air blocking layer between the reflective layer and the core layer, the air blocking layer is for restricting movement of air in a thickness direction of the cover layer.

4. The vehicular interior component according to claim 1, wherein
the cover layer includes an air blocking layer for restricting movement of air in a thickness direction of the cover layer, and
the second section is included in the air blocking layer.

5. The vehicular interior component according to claim 1, wherein the second section of the cover layer includes recesses between the projection portions.

6. The vehicular interior component according to claim 5, wherein the core layer includes first recesses corresponding to the recesses of the cover layer, respectively, and the first recesses are recessed from the vehicular exterior side surface of the core layer.

7. The vehicular interior component according to claim 1, wherein
the vehicular component is a curtain airbag that extends in a vehicular front-rear direction and the curtain airbag includes at least two curtain airbags,
the second section includes at least two second sections that extend in the vehicular front-rear direction and the at least two second sections are disposed to sandwich the first section with respect to a vehicular width direction, and
the at least two second sections are opposite the at least two curtain airbags, respectively.

8. The vehicular interior component according to claim 1, wherein the vehicular interior component is configured as a ceiling of a vehicle.

9. The vehicular interior component according to claim 1, wherein
the second section of the cover layer includes recesses between the projection portions, and
the projection portions have contact surfaces that are portions of the second vehicular exterior side surface.

10. The vehicular interior component according to claim 9, wherein the recesses are in the cover layer and recessed toward a vehicular interior side from the second vehicular exterior side surface.

11. The vehicular interior component according to claim 9, wherein the recesses have bottom surfaces and the bottom surfaces are on the vehicular interior side with respect to the vehicular exterior side surface of the core layer.

12. The vehicular interior component according to claim 9, wherein the recesses have bottom surfaces that are away from contact portions of the body panel or the vehicular component that are to be contacted with the projection portions of the second section.

13. The vehicular interior component according to claim 1, wherein
the vehicular interior component is a plate member,
the first section is included in a middle section of the plate member, and
the second section is included in an edge section of the plate member.
